(19) United States
(12) Patent Application Publication
(10) Pub. No.: US 2024/0304070 A1
(43) Pub. Date: Sep. 12, 2024

(54) Commercial Vehicle With Tool Storage Sensors

(71) Applicant: J.B. Poindexter & Company, Houston, TX (US)

(72) Inventors: Casey Alford, Houston, TX (US); Gregg Black, Houston, TX (US); Gregory Ohl, Houston, TX (US); Gregory Weber, Houston, TX (US); Justin Floro, Houston, TX (US); Kris Schilling, Houston, TX (US); Rodrigo Felix, Houston, TX (US)

(21) Appl. No.: 18/595,041

(22) Filed: Mar. 4, 2024

Related U.S. Application Data
(60) Provisional application No. 63/488,794, filed on Mar. 7, 2023.

(51) Int. Cl. G08B 13/24; G08B 21/24; H04W 4/80

(52) U.S. Cl. CPC G08B 13/2428; G08B 21/24; H04W 4/80

(57) ABSTRACT

Vehicles and systems for vehicles are disclosed. The systems can provide integrated cooperation across multiples aspects of the vehicle. For example, the vehicle can comprise a plurality of sensors and a computing device in communication with the plurality of sensors. The computing device can comprise at least one processor and a memory. A display can be in communication with the computing device. The computing device can be configured to display information associated with data from the plurality of sensors.

### CROSS-REFERENCE TO RELATED APPLICATION

This application claims priority to and the benefit of the filing date of U.S. Provisional Patent Application No. 63/488,794, filed Mar. 7, 2023, the entirety of which, including the appendices, is incorporated by reference herein.

### FIELD

This disclosure relates to vehicles and systems therefor.

### BACKGROUND

Vehicles (e.g., vehicles for commercial and industrial applications) conventionally have complex, non-integrated systems. For example, a speedometer is provided as a first display (e.g., a liquid crystal diode (LCD) screen) on a dashboard, and a tire monitor is provided on a separate display (e.g., an indicator light) of the dashboard. The different systems require their own wiring networks to the respective displays. As new features are added to vehicles, the nonintegrated systems lead to undesirable clutter of displays and wiring. Further, conventionally, the different systems are not in communication, so the information relayed to an operator can be overwhelming or incomplete. Still further, the absence of communication between systems in conventional vehicles makes analysis and synthesis of information difficult and/or impractical.

Additionally, vehicles such as those for commercial and industrial applications can have various tools associated therewith. These tools can be expensive and can lead to economic loss if lost or left at a job site, requiring a return trip. Accordingly, a system for reducing lost tools desirable.

### SUMMARY

Disclosed herein are vehicles and systems for vehicles.

Disclosed herein, in one aspect, is a vehicle comprising at least one tool sensor. Each tool sensor of the at least one tool sensor is configured to detect a status of at least one associated tool at the vehicle. The vehicle can further comprise a display and at least one processor in communication with the display and the at least one tool sensor. The at least one processor can be configured to receive a signal indicative of the status of each tool of the at least one tool associated with the at least one tool sensor; and cause the display to display the status of each tool of the at least one tool associated with the at least one tool sensor based on the signal received from the at least one tool sensor. The vehicle can further comprise a transmitter that is configured to transmit signals associated with the status of each tool to a remote device.

Also disclosed herein is a system comprising a vehicle and a remote computing device in communication with the transmitter of the vehicle. The remote computing device comprises a display. The remote computing device is configured to display on the display of the remote computing device the status of each tool.

Exemplary systems disclosed herein can provide integrated cooperation across multiples aspects of the vehicle. For example, the vehicle can comprise a plurality of sensors and a computing device in communication with the plurality of sensors. The computing device can comprise at least one processor and a memory. A display can be in communication with the computing device. The computing device can be configured to display information associated with data from the plurality of sensors.

Additional advantages of the disclosed apparatuses, systems, and methods will be set forth in part in the description that follows, and in part will be obvious from the description, or may be learned by practice of the claimed invention. The advantages of the disclosed devices and systems will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a block diagram of a system comprising a vehicle as disclosed herein and a remote device in communication with the vehicle.

FIG. 2 shows an exemplary output on a display of the vehicle.

FIG. 3 shows an exemplary output on a display of the remote device.

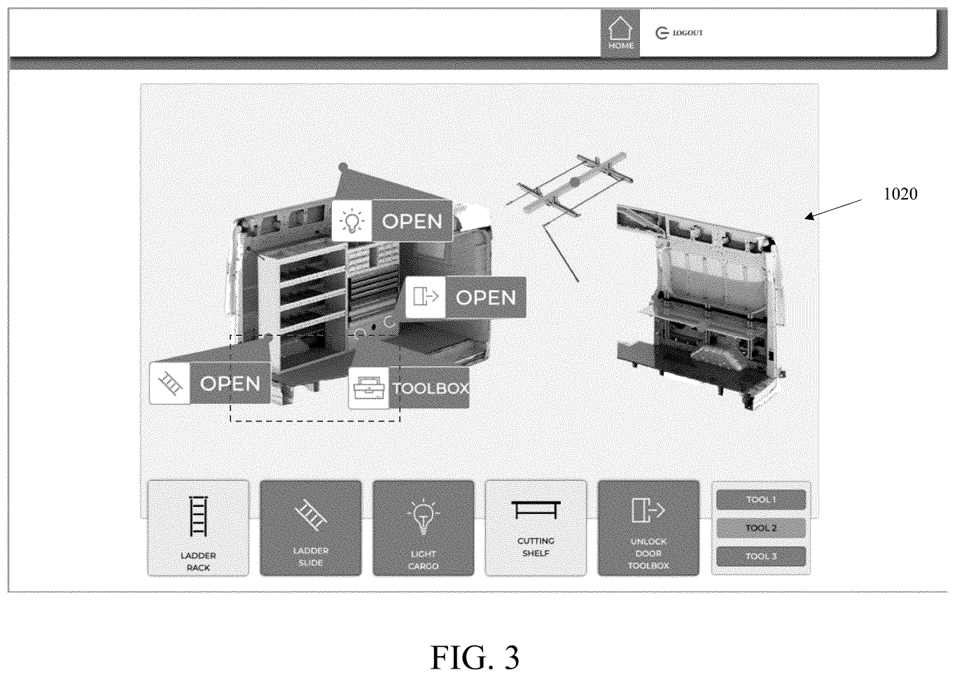

FIG. 4 a block diagram of a computing system comprising computing devices as disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a sensor” can refer to one or more of such sensors, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of” For example, “at least one of A, B and C” explicitly includes only A, only B, only C, and combinations of each.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

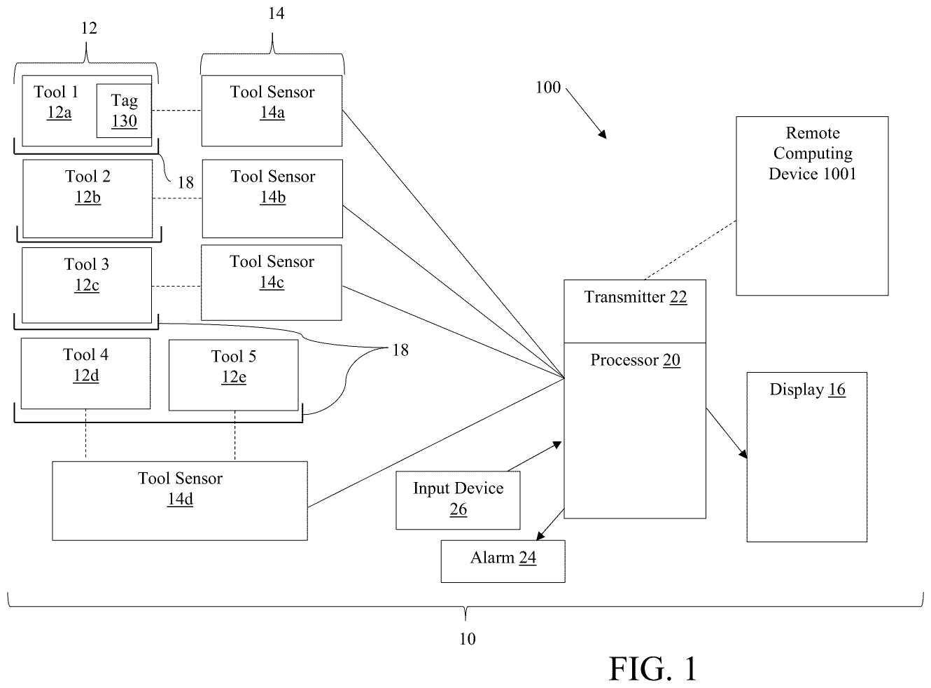

Referring to FIG. 1, a vehicle 10 (e.g., a commercial vehicle, a delivery vehicle, a work truck, or the like) comprises at least one tool sensor 14. Each tool sensor 14 of the at least one tool sensor can be configured to detect a status of at least one associated tool 12 at the vehicle 10. For example, the status can be either a presence of the tool or an absence of the tool. In other aspects, the status can be an improperly stowed tool. For example, the at least one tool sensor can be configured to detect a presence of the tool, but that the tool is not in a proper location (e.g., a designated receptacle).

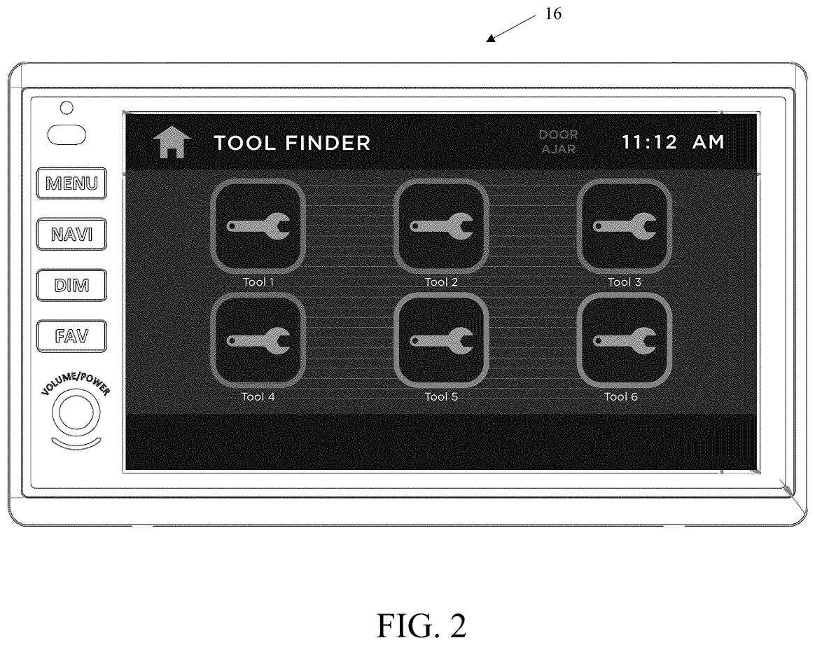

Referring also to FIG. 2, the vehicle 10 can further comprise a display 16 and at least one processor 20 in communication with the display and the at least one tool sensor 14. The at least one processor 20 can be configured to: receive a signal indicative of the status of each tool 12 of the at least one tool associated with the at least one tool sensor 14; and cause the display 16 to display the status of each tool of the at least one tool associated with the at least one tool sensor based on the signal received from the at least one tool sensor.

The vehicle 10 can further comprise a transmitter that is configured to transmit signals associated with the status of each tool to a remote device 1001.

In some aspects, the vehicle can comprise a plurality of tool sensors (e.g., tool sensor 14a, tool sensor 14b, and tool sensor 14c), wherein each tool sensor is associated with a respective tool (e.g., tool 12a, tool 12b, and tool 12c, respectively). In other aspects, a tool sensor (e.g., tool sensor 14d) can be configured to detect the status (e.g., presence or absence) of a plurality of tools (tools 12d,e).

In some aspects, the vehicle can comprise a plurality of tool receptacles 18. Each tool 12 can be associated with a respective tool receptacle 18 of the plurality of tool receptacles. Optionally, in these aspects, the status detected by the at least one tool sensor can be a presence of the tool or an absence of the tool in the respective tool receptacle associated with the tool.

In exemplary aspects, the receptacle can be a receptacle that is specific to a single tool (e.g., a designated compartment or rack element). For example, in some aspects, at least one tool receptacle can be configured to receive only one tool (e.g., a single tool of a particular type). Optionally, each tool receptacle of the at least one tool receptacle is sized to receive only one tool (e.g., with each receptacle configured to receive a respective tool, optionally of a particular type). In further aspects, one or more (optionally, all) of the at least one tool receptacle can define a shape that corresponds to an outer perimeter of only one tool type so that other types of tools cannot be positioned within the tool receptacle.

In other aspects, the receptacle can be a general region of the vehicle (e.g., a cargo area, a region in the cargo area, a cabinet, a drawer, a rack, or a hanger). For example, in some aspects at least one tool receptacle can be configured to receive at least two tools. In some aspects, the at least one tool sensor comprises at least two sensors that are each configured to detect a status (e.g., presence) of a respective tool of the at least two tools. In other aspects, a single sensor can detect the status (e.g., presence) of the at least two tools.

In some aspects, at least a first tool sensor 14a of the at least one tool sensor 14 can comprise a wireless sensor that is configured to detect a tag associated with the wireless sensor. In these aspects, the tool 12 can comprise the tag 30 associated with the wireless sensor. In various exemplary aspects, the wireless sensor can be configured to communicate with the tag via Bluetooth low energy (BLE) or radio frequency identification (RFID). In some aspects, the wireless sensor and tag 30 can be tuned to detect the tag within a predetermined range. In some aspects, the predetermined range can be within about 2 meters, or within about 1 meter, or within about ½ meter, or within about 10 cm. In this way, the wireless sensor can avoid false detection of the tool that is outside of (e.g., next to, but close to), or not properly stored within, the vehicle 10.

In some optional aspects, the wireless sensor can comprise a plurality of sensor elements that are configured to cooperate to define a mesh region. The wireless sensor can be further configured to detect a location of the tag within the mesh region. For example, the plurality of sensor elements of the wireless sensor can cooperate to triangulate the location of the tool based on signal strength at each sensor element.

In some aspects, at least a first tool sensor of the at least one tool sensor comprises a mechanical switch, a pressure sensor, or an optical sensor, or combinations thereof.

The vehicle 10 can further comprise an alarm 24 or a plurality of alarms. For example, the alarm 24 can be an audible and/or a visible alarm. In some aspects, the visible alarm can be provided on the display 16. In other aspects, the visible alarm can be a separate visible indicator, such as a flashing light. In further aspects, the audible alarm can be a speaker (e.g., the audio system of the vehicle) or a separate speaker or buzzer. The vehicle 10 can be configured to activate the alarm 24 based on the status of at least one tool and an event indicative of operation of the vehicle. The event indicative of operation of the vehicle comprises one of the vehicle being started, the vehicle being shifted out of park, or movement of the vehicle (e.g., movement for a predetermined duration). In this way, the vehicle can let the operator know if the operator is about to drive away without a tool (or without the tool properly stowed).

In some aspects, the vehicle can comprise an input device 26 in communication with the processor. The input device 26 can be configured to receive an input from an operator. The processor can be configured to, based on the input from the operator, either silence an alarm or override a status of one or more of the tools. In various aspects, the input device can be a touchscreen or keypad.

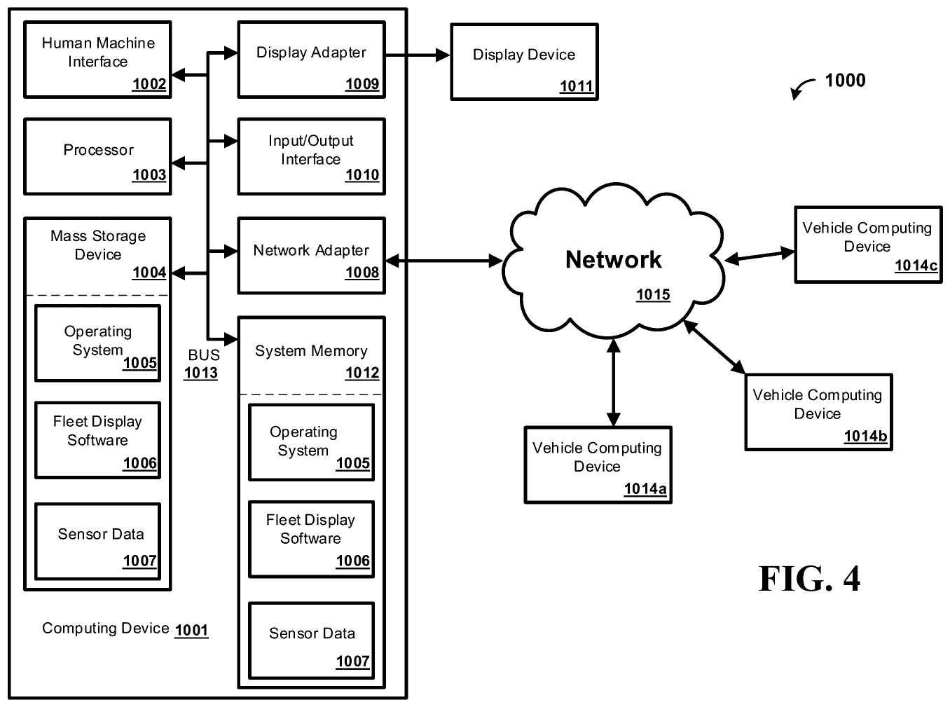

A system 100 can comprise a vehicle 10 and a remote computing device 1001 in communication with the transmitter 22 of the vehicle. The remote computing device 1001 can comprise a display (device) 1011 (FIG. 4). The remote computing device 1001 can be configured to display on the display of the remote computing device 1001 the status of each tool. In various aspects, the transmitter 22 can be configured to transmit status information wirelessly via cellular technologies (e.g., SMS, 2G, 3G, 4G, 5G, etc.).

In some optional aspects, the transmitter 22 can be a transceiver. In these aspects, the remote computing device 1001 can be configured to query the vehicle 10 or change at least one aspect of the vehicle (e.g., override a sensor indication). For example, in some aspects, the remote computing device 1001 can comprise a dispatch input device 1020 (FIG. 4) in communication with the remote computing device. The remote computing device can be configured to receive a dispatcher input from the dispatch input device. The remote computing device can be configured to cause the processor of the vehicle to one of silence an alarm or override a status of a first tool.

Operators can be immediately alerted if the desired tools are not present in the vehicle through the system. The system is described in the diagram of FIG. 1. There is a specific region of the truck (such as a toolbox accessible from the outside or inside on a work truck body or van) where a tool is expected to be when a vehicle is no longer stationary (e.g., leaves to perform a job or after completing a job). The presence of a specific tool can be detected by the computer using input from wireless technology such as Bluetooth low energy (BLE) or radio-frequency identification (RFID), which can sense the proximity between a gateway and the tool or, in a mesh configuration, can locate the tool more precisely within the mesh region. After determining presence of a particular tool, the processor transmits that information for display inside the vehicle (e.g., with a message over a controller area network (CAN)) and for remote tracking and display (e.g., with a data package over a cellular network to a remote computer system). Furthermore, when the vehicle is no longer stationary for a predetermined time interval, an alert (e.g., audible inside the cabin) may be generated for any missing assets and communicated in the same manner.

Tools contemplated for tracking and sensing using embodiments disclosed herein range across all commercial and industrial applications. For example, exemplary tools include mechanical tools (e.g., drills, hammers, ladders, hydraulic and pneumatic devices), measurement tools (e.g., laser measurement tools, ultrasonic measurement tools), cameras, electrical devices, computers, plumbing and water, sewage, or fluid handling devices, or oil/gas applications. Tools sensed and tracked using embodiments disclosed herein are not limited to the foregoing examples, and any tool suitable for transport and use with a vehicle is contemplated.

It is contemplated that advantages of the disclosed vehicles and systems can include:
Less wasted time returning to the shop or jobsite for forgotten tools;
Fewer delays on upcoming jobs due to missing tools;
Loss prevention for expensive tools and equipment; and
Helps keep tools and equipment in ready state.

Disclosed herein are vehicles and systems for vehicles to provide integrated cooperation across multiples aspects of the vehicle. For example, the vehicle can comprise a plurality of sensors and a computing device in communication with the plurality of sensors. The computing device can comprise at least one processor and a memory. A display can be in communication with the computing device. The computing device can be configured to display information associated with data from the plurality of sensors.

The plurality of sensors can comprise at least one vision sensor, such as a camera, a laser sensor (e.g., LIDAR), or other suitable vision sensor as is known in the art. The vision sensor can be configured to detect obstacles, other vehicles, etc. An alarm or warning can be triggered in response to signals received by the visions sensor(s).

The computing device can be configured to provide a user with user-selectable options and receive an input from the user corresponding to at least one of the user-selectable option. At least one user-selectable option can be associated with lighting of the vehicle (e.g., a timing for a light to turn on or off).

The plurality of sensors can comprise a tool sensor that is configured to detect a presence or absence of a tool within the vehicle. The computing device can be configured to provide an alert upon receiving a signal from the tool sensor indicative that the tool is absent. For example, certain tools can be secured in a particular location. The computing device can, via the tool sensor, detect the absence of the tool from the particular location. Further, for trucks having a toolbox, a toolbox sensor can determine whether the toolbox is open or closed (and/or unlocked/locked).

In further aspects, certain features can be locked without proper access. For example, tools, a tool box, or the vehicle itself can be locked without access.

The plurality of sensors comprise at least one vehicle condition sensor, such as, for example, but not limited to, sensors that are configured to detect one or more of: cabinet and vehicle doors left open, lift gate left down, steps deployed, or any mechanical device in an unsecure condition for vehicle movement, or combinations thereof. Such sensors can include proximity sensors, motion sensors, and the like.

The vehicle can comprise a windshield heater that is in communication with the computing device. The computing device can be configured to control operation of the windshield heater.

Certain features can be checked remotely (e.g., via an application on a remote computing device, such as a smartphone). For example, one or more of the following can be checked: Passive infrared sensor (PIR) (front, mid, rear), Doors, Cab, Cargo, Bulkhead, Roadside, Curbside (open/closed), Lights; Headlight, Cargo, External worklight (on/off), Equipment Deployed (e.g. roof solar panel), Equipment Secured (e.g. ladder, cargo cutting shelf), Tire pressure (monitor), Battery SOC (monitor), GPS location (monitor), Ignition on/off (monitor), Cargo Temperature (monitor), Vehicle motion (e.g., Park, Reverse, Neutral, Drive, and Low, or PRNDL) status, Speed status, or Remaining range estimation, or combinations thereof.

In some aspects, via an application on a remote device, various features of the vehicle can be operated. For example, lights (headlights, tail, brake, reserve, marker, DRL, cabin, cargo, porch, stepwell) can be turned on or off; and toolbox access (e.g., via lock/unlock) can be given or revoked.

In some aspects, the vehicle can comprise passive recognition (e.g., for entry, authentication, or status). For example, the vehicle can comprise a detector that detects a fob via low frequency RF or RFID. This can avoid the need to operate a push button. The detection distance can be short (e.g., a few feet, within about 2 feet, or somewhere within the truck).

The vehicle can further comprise remote recognition for actions such as permitting entry, authentication, and status checks. The distance for this remote recognition can be several yards (e.g., 5-20 yards). For example, the vehicle can comprise a sensor that is configured to recognize a fob or other wireless device carried by an operator to permit remote recognition. In additional aspects, the vehicle can comprise an application on a smartphone, tablet, or other such device that is configured to communicate with the vehicle to permit permitting entry, authentication, and status checks. For example, remote recognition can be used to permit unlocking of doors, authentication to start the vehicle or permit access to specific tools or toolboxes. In still further aspects, remote recognition (e.g., via smartphone) can permit display the status of one or more vehicle settings (e.g., battery charge, on/off status, or tool sensor status).

### Exemplary Computing Device

FIG. 4 shows an exemplary computing system 1000 including an exemplary configuration of a computing device 1001 for use with the system 100 (FIG. 1) disclosed herein. For example, the computing device 1001 can be the remote computing device 102 (FIG. 1). The processor of the vehicle can be an element of a computing device in accordance with the description of the computing device 1001 as disclosed herein.

The computing device 1001 may comprise one or more processors 1003, a system memory 1012, and a bus 1013 that couples various components of the computing device 1001 including the one or more processors 1003 to the system memory 1012. In the case of multiple processors 1003, the computing device 1001 may utilize parallel computing.

The bus 1013 may comprise one or more of several possible types of bus structures, such as a memory bus, memory controller, a peripheral bus, an accelerated graphics port, and a processor or local bus using any of a variety of bus architectures.

The computing device 1001 may operate on and/or comprise a variety of computer readable media (e.g., non-transitory). Computer readable media may be any available media that is accessible by the computing device 1001 and comprises, non-transitory, volatile and/or non-volatile media, removable and non-removable media. The system memory 1012 has computer readable media in the form of volatile memory, such as random access memory (RAM), and/or non-volatile memory, such as read only memory (ROM). The system memory 1012 may store data such as sensor data 1007 and/or program modules such as operating system 1005 and fleet display software 1006 that are accessible to and/or are operated on by the one or more processors 1003.

The computing device 1001 may also comprise other removable/non-removable, volatile/non-volatile computer storage media. The mass storage device 1004 may provide non-volatile storage of computer code, computer readable instructions, data structures, program modules, and other data for the computing device 1001. The mass storage device 1004 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 1004. An operating system 1005 and fleet display software 1006 may be stored on the mass storage device 1004. One or more of the operating system 1005 and fleet display software 1006 (or some combination thereof) may comprise program modules and the indicator control software 1006. The sensor data 1007 may also be stored on the mass storage device 1004. The sensor data 1007 may be stored in any of one or more databases known in the art. The databases may be centralized or distributed across multiple locations within the network 1015.

A user may enter commands and information into the computing device 1001 using an input device 1020. Such input devices comprise, but are not limited to, a joystick, a touchscreen display, a keyboard, a pointing device (e.g., a computer mouse, remote control), a microphone, a scanner, tactile input devices such as gloves, and other body coverings, motion sensor, speech recognition, and the like. These and other input devices may be connected to the one or more processors 1003 using a human machine interface 1002 that is coupled to the bus 1013, but may be connected by other interface and bus structures, such as a parallel port, game port, an IEEE 1394 Port (also known as a Firewire port), a serial port, network adapter 1008, and/or a universal serial bus (USB).

A display device 1011 may also be connected to the bus 1013 using an interface, such as a display adapter 1009. It is contemplated that the computing device 1001 may have more than one display adapter 1009 and the computing device 1001 may have more than one display device 1011. A display device 1011 may be a monitor, an LCD (Liquid Crystal Display), light emitting diode (LED) display, television, smart lens, smart glass, and/or a projector. In addition to the display device 1011, other output peripheral devices may comprise components such as speakers (not shown) and a printer (not shown) which may be connected to the computing device 1001 using Input/Output Interface 1010. Any step and/or result of the methods may be output (or caused to be output) in any form to an output device. Such output may be any form of visual representation, including, but not limited to, textual, graphical, animation, audio, tactile, and the like. The display device 1011 and computing device 1001 may be part of one device, or separate devices.

The computing device 1001 may operate in a networked environment using logical connections to one or more vehicle computing devices 1014a,b,c. A vehicle computing device 1014a,b,c may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The vehicle computing devices 1014a,b,c, can perform respective operations of the system 200 (FIG. 2). Logical connections between the computing device 1001 and a vehicle computing device 1014a,b,c may be made using a network 1015, such as a local area network (LAN) and/or a general wide area network (WAN), or a Cloud-based network. Such network connections may be through a network adapter 1008. A network adapter 1008 may be implemented in both wired and wireless environments. Such networking environments are conventional and commonplace in dwellings, offices, enterprise-wide computer networks, intranets, and the Internet. It is contemplated that the vehicle computing devices 1014a,b,c can optionally have some or all of the components disclosed as being part of computing device 1001. In various further aspects, it is contemplated that some or all aspects of data processing described herein can be performed via cloud computing on one or more servers or other vehicle computing devices. Accordingly, at least a portion of the operating environment 1000 can be configured with internet connectivity.

Although the foregoing invention has been described in some detail by way of illustration and example for purposes of clarity of understanding, certain changes and modifications may be practiced within the scope of the appended claims.

What is claimed is:

1. A vehicle comprising:
at least one tool sensor, wherein each tool sensor of the at least one tool sensor is configured to detect a status of at least one associated tool at the vehicle;
a display;
at least one processor in communication with the display and the at least one tool sensor, wherein the at least one processor is configured to:
receive a signal indicative of the status of each tool of the at least one tool associated with the at least one tool sensor; and
cause the display to display the status of each tool of the at least one tool associated with the at least one tool sensor based on the signal received from the at least one tool sensor; and
a transmitter that is configured to transmit signals associated with the status of each tool to a remote device.

2. The vehicle of claim 1, wherein the status of each tool detected by the at least one tool sensor is either a presence of the tool or an absence of the tool.

3. The vehicle of claim 1, further comprising a plurality of tool receptacles, wherein each tool is associated with a respective tool receptacle of the plurality of tool receptacles, wherein the status detected by the at least one tool sensor is a presence of the tool or an absence of the tool in the respective tool receptacle with which the tool is associated.

4. The vehicle of claim 3, wherein at least one tool receptacle is configured to receive only one tool.

5. The vehicle of claim 4, wherein each tool receptacle of the at least one tool receptacle is sized to receive only one tool.

6. The vehicle of claim 5, wherein the at least one tool receptacle defines a shape that corresponds to an outer perimeter of the only one tool.

7. The vehicle of claim 3, wherein at least one tool receptacle is configured to receive at least two tools.

8. The vehicle of claim 7, wherein the at least one tool sensor comprises at least two sensors that are each configured to detect a presence of a respective tool of the at least two tools.

9. The vehicle of claim 1, wherein at least a first tool sensor of the at least one tool sensor comprises a wireless sensor that is configured to detect a tag associated with the wireless sensor.

10. The vehicle of claim 9, further comprising a tool, wherein the tool comprises the tag associated with the wireless sensor.

11. The vehicle of claim 10, wherein the wireless sensor is configured to communicate with the tag via Bluetooth low energy (BLE) or radio frequency identification (RFID).

12. The vehicle of claim 9, wherein the wireless sensor comprises a plurality of sensor elements that are configured to cooperate to define a mesh region, wherein the wireless sensor is configured to detect a location of the tag within the mesh region.

13. The vehicle of claim 1, wherein at least a first tool sensor of the at least one tool sensor comprises a mechanical switch, a pressure sensor, or an optical sensor.

14. The vehicle of claim 1, further comprising an alarm, wherein the vehicle is configured to activate the alarm based on the status of at least one tool and an event indicative of operation of the vehicle.

15. The vehicle of claim 14, wherein the event indicative of operation of the vehicle comprises one of: the vehicle being started; or the vehicle being shifted out of park; or movement of the vehicle.

16. The vehicle of claim 1, further comprising an input device in communication with the at least one processor, wherein the input device is configured to receive an input from an operator, wherein the at least one processor is configured to, based on the input from the operator, one of:
silence an alarm; or
override a status of a first tool.

17. A system comprising:
a vehicle as in claim 1; and
a remote computing device in communication with the transmitter of the vehicle, wherein the remote computing device comprises a display, wherein the remote computing device is configured to display on the display of the remote computing device the status of each tool.

18. The system of claim 17, further comprising a dispatch input device in communication with the remote computing device, wherein the remote computing device is configured to receive a dispatcher input from the dispatch input device, wherein the remote computing device is configured to cause the at least one processor of the vehicle to one of:
silence an alarm; or
override a status of a first tool.
